(19) United States
(12) Patent Application Publication
(10) Pub. No.: US 2025/0030103 A1
(43) Pub. Date: Jan. 23, 2025

(54) BATTERY SYSTEM ENCLOSURE WITH BATTERY CELL VENTING COLLECTION BAG FOR THERMAL RUNAWAY MITIGATION

(71) Applicant: GM GLOBAL TECHNOLOGY OPERATIONS LLC, Detroit, MI (US)

(72) Inventors: Anil Yadav, Troy, MI (US); Mukesh Gangadharaiah, Mysore (IN)

(73) Assignee: GM GLOBAL TECHNOLOGY OPERATIONS LLC, Detroit, MI (US)

(21) Appl. No.: 18/354,002

(22) Filed: Jul. 18, 2023

(51) Int. Cl. H01M 50/249; B60L 50/64; H01M 50/209; H01M 50/213; H01M 50/222; H01M 50/317

(52) U.S. Cl. CPC H01M 50/249; B60L 50/64; H01M 50/209; H01M 50/213; H01M 50/222; H01M 50/317; H01M 2220/20

(57) ABSTRACT

A battery system includes a first battery cell and a neighboring second battery cell. The battery system also includes a battery system enclosure surrounded by an external environment and configured to house the first and second battery cells. The battery system additionally includes a collection bag housed within the battery system enclosure and fixed to each battery cell. The collection bag is configured to capture high-temperature gases and/or debris vented by at least one of the battery cells. The collection bag is also configured to divert the captured high-temperature gases and/or debris of each battery cell away from the other battery cell. The collection bag thereby reduces transfer of the high-temperature gases and/or debris between the battery cells and mitigates propagation of a thermal runaway event in the battery system. The collection bag is further configured to expel the captured high-temperature gases and/or debris to the external environment.

### INTRODUCTION

The present disclosure relates to a battery system enclosure with a battery cell venting collection bag for mitigating a thermal runaway event in the battery system.

A battery cell array, such as a battery module, pack, etc., typically includes a plurality of battery cells in relatively close proximity to one another. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Such chemical reactions may cause more heat to be generated by the batteries than is effectively withdrawn. Exposure of a battery cell to elevated temperatures over prolonged periods may cause the cell to experience a thermal runaway event. Accordingly, a thermal runaway event starting within an individual cell may lead to the heat spreading to adjacent cells in the battery cell array and cause the thermal runaway event to affect the entire array.

### SUMMARY

A battery system includes a first battery cell and a neighboring second battery cell. The battery system also includes a battery system enclosure surrounded by an external environment and configured to house each of the first and second battery cells. The battery system additionally includes a collection bag housed within the battery system enclosure and fixed to each of the first and second battery cells. The collection bag is configured to capture high-temperature gases and/or debris vented by at least one of the first and second battery cells. The collection bag is also configured to divert the captured high-temperature gases and/or debris of each of the first and second battery cells away from the other of the first and second battery cells. The collection bag thereby reduces transfer of the high-temperature gases and/or debris between the battery cells and mitigates propagation of a thermal runaway event in the battery system. The collection bag is further configured to expel the captured high-temperature gases and/or debris to the external environment.

The collection bag may include an exit port having a one-way valve. The one-way valve is intended to control expelling of the high-temperature gases from the collection bag to the external environment.

The battery system enclosure may include an enclosure tray and a mating enclosure cover. In such an embodiment, the one-way valve may be fixed either to the enclosure tray or to the enclosure cover.

The collection bag may be arranged between the enclosure cover and the first and second battery cells.

The collection bag may include individual first and second entry ports with respective first and second interfaces configured to lock onto, e.g., snap onto, the respective first and second battery cells.

The collection bag may include first and second mica material portions arranged to line, e.g., cover and reinforce, the respective first and second entry ports and thermally protect the respective first and second interfaces.

The collection bag may be constructed from a flexible, temperature-resistant material and include stitching configured to generate individual flow paths for the high-temperature gases and/or debris of each of the first and second battery cells.

The collection bag may additionally include projections arranged inside the individual flow paths configured to catch and retain the high-temperature debris inside the collection bag.

The flexible, temperature-resistant material may include either black slag or vermiculite.

The collection bag may include a bellows structure configured to expand under pressure of the high-temperature gases.

A motor vehicle having a power-source and the above-disclosed battery system configured to supply electric energy to the power-source is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources and a battery system having battery cells arranged in arrays configured to generate and store electrical energy.

FIG. 2 is a schematic side view of two exemplary embodiments of battery cells shown in FIG. 1, each battery cell depicted having a respective gas vent.

FIG. 3 is a schematic side view of the battery array shown in FIG. 1, illustrating an enclosure for housing the battery cells and a gas and debris collection bag arranged within the enclosure, according to the present disclosure.

FIG. 4 is a schematic side view of the battery array shown in FIG. 3, illustrating the gas and debris collection bag capturing high-temperature gases and debris vented by one of the battery cells, according to the present disclosure.

FIG. 5 is a schematic top view of the battery array shown in FIG. 3, illustrating the gas and debris collection bag arranged within the enclosure and having individual mica liners, according to the present disclosure.

FIG. 6 is a schematic cross-sectional partial side view of the gas and debris collection bag having projections arranged inside individual flow paths, according to the present disclosure.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

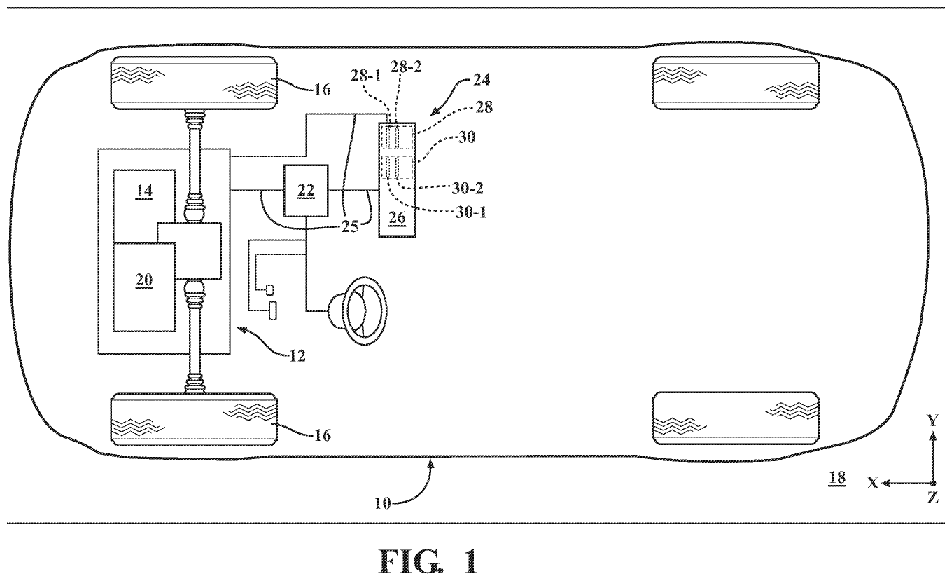

Referring to FIG. 1, a motor vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque for propulsion of the vehicle 10 via driven wheels 16 relative to a road surface 18. The power-source 14 is depicted as an electric motor-generator.

As shown in FIG. 1, the powertrain 12 may also include an additional power-source 20, such as an internal combustion engine. The power-sources 14 and 20 may act in concert to power the vehicle 10. The vehicle 10 additionally includes an electronic controller 22 and a battery system 24 configured to generate and store electrical energy through heat-producing electro-chemical reactions for supplying the electrical energy to the power-sources 14 and 20. The electronic controller 22 may be a central processing unit (CPU) that regulates various functions of the vehicle 10, or as a powertrain control module (PCM) configured to control the powertrain 12 to generate a predetermined amount of power-source torque. The battery system 24 may be connected to the power-sources 14 and 20, the electronic controller 22, as well as other vehicle systems via a high-voltage BUS 25. Although the battery system 24 is described herein primarily with respect to a vehicle environment, nothing precludes the subject battery system from being employed to power other, non-automotive systems.

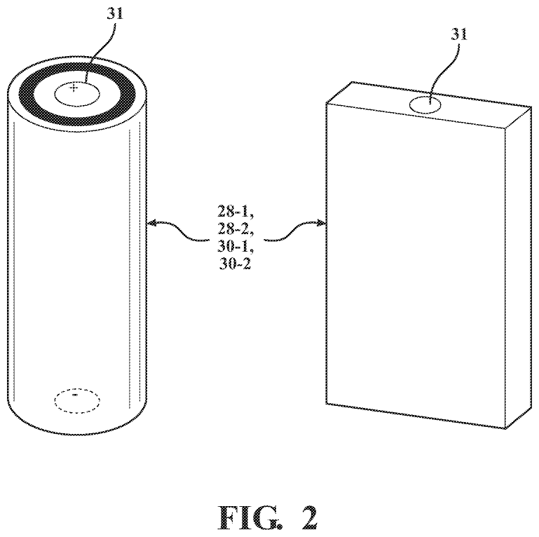

With continued reference to FIG. 1, the battery system 24 includes one or more sections or arrays 26 of individual battery cells with respect to an X-Y-Z coordinate system. Each battery cell array 26 may be configured as a battery module or a number of battery modules bundled into a battery pack. The array 26 includes a plurality of battery cells, such as a first group of battery cells 28 and a neighboring, directly adjacent, second group of battery cells 30, each extending generally upward, i.e., in the Z direction. Although one array 26 (illustrated as a battery pack) and two groups of battery cells 28, 30 (illustrated as individual modules) are specifically indicated, nothing precludes the battery system 24 from having a greater number of such arrays with a particular number of battery cells arranged therein. As shown, the first cell group 28 includes at least first and second battery cells 28-1, 28-2, while the neighboring second cell group 30 includes at least first and second battery cells 30-1, 30-2. As shown, each battery cell in the groups 28 and 30 may be configured as a cylindrical or a prismatic cell, extending generally upward in an X-Z plane. Each such battery cell generally includes a respective cell vent 31 (illustrated in FIG. 2) in a predefined location on a cell casing for expelling or venting high-pressure gases. Such a cell vent 31 is typically located at the upper portion of the corresponding battery cell.

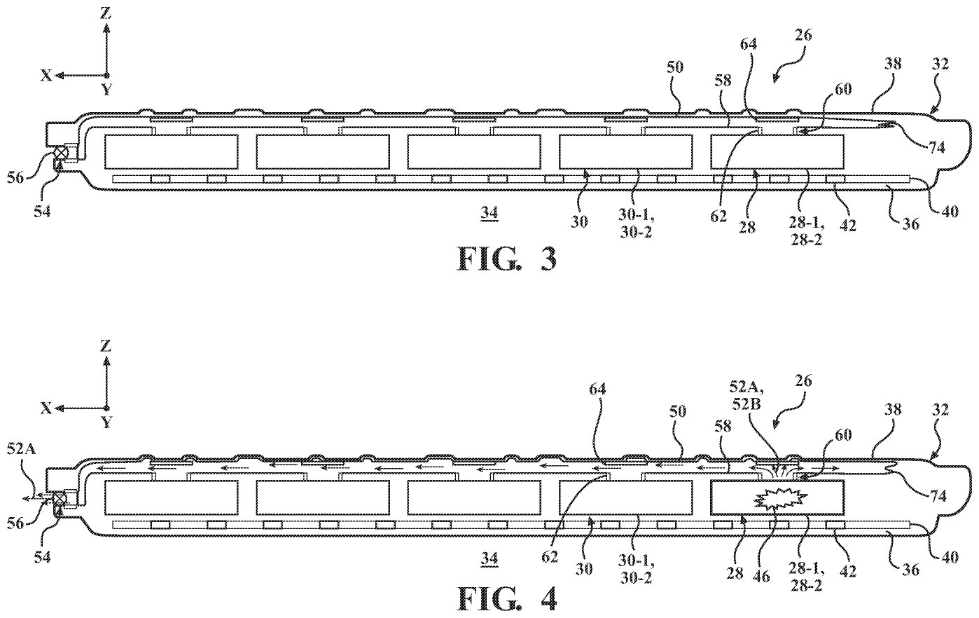

As shown in FIGS. 3 and 4, the battery system 24 also includes a battery system enclosure 32 configured to house each of the first and second battery cell groups 28, 30. The battery system enclosure 32 is surrounded by an ambient environment 34. i.e., environment external to the battery system enclosure. The battery system enclosure 32 is configured to manage high-temperature gases emitted by battery cells in the cell groups 28, 30, such as during a battery cell thermal runaway event, and expel the high-temperature gases to the external environment 34. The battery system enclosure 32 includes an enclosure tray 36 and an enclosure cover 38. The battery cells of cell groups 28, 30 are generally set on the enclosure tray 36. The enclosure cover 38 is generally positioned above the battery cell groups 28, 30 and configured to engage the enclosure tray 36 to substantially seal the battery system enclosure 32 and its contents from the external environment 34. As shown, the battery system enclosure 32 is arranged in a horizontal X-Y plane, such that the enclosure cover 38 is positioned above the enclosure tray 36 when viewed along a Z-axis.

As also shown in FIGS. 3 and 4, the battery system 24 may additionally include a heat sink 40. The heat sink 40 is generally positioned below and in direct contact with the battery cells of the first and second battery cell groups 28, 30 to thereby absorb thermal energy from the respective battery cells. As shown, the heat sink 40 may be in direct physical contact with the battery cells of the first and second cell groups 28, 30. The heat sink 40 may be configured as a coolant plate having a plurality of coolant channels 42. The coolant channels 42 are specifically configured to circulate a coolant and thereby remove thermal energy from the first and second battery cell groups 28, 30 while the battery cell array 26 generates/stores electrical energy.

Generally, during normal operation of the battery cell array 26, the heat sink 40 is effective in absorbing thermal energy released by the first and second battery cell groups 28, 30. However, during extreme conditions, such as during a thermal runaway event (identified via numeral 46 in FIG. 4), the amount of thermal energy released by the cell undergoing the event may saturate the heat sink 40 and exceed capacity of the battery cell array 26 to efficiently transfer heat, e.g., from the battery system enclosure 32 to the ambient environment 34. As a result, excess thermal energy will typically be transferred between the neighboring cells of each of the respective first and second battery cell groups 28, 30 and between the two groups, leading to propagation of the thermal runaway through the battery cell array 26. The term “thermal runaway event” generally refers to an uncontrolled increase in temperature in a battery system. During a thermal runaway event, the generation of heat within a battery system or a battery cell exceeds the dissipation of heat, thus leading to a further increase in temperature. A thermal runaway event may be triggered by various conditions, including a short circuit within the cell, improper cell use, physical abuse, manufacturing defects, or exposure of the cell to extreme external temperatures.

For example, in the event one battery cell in the first battery cell group 28, such as the cell 28-1, experiences the thermal runaway event 46, the excess gases generated by such an event would give rise to highly elevated internal cell pressures having tendency to rupture casing of the subject cell. In the event of the battery cell 28-1 casing rupture, high-temperature gases (with temperatures up to 1,500 degrees Celsius) emitted by the subject battery cell may send cell debris through the first battery cell group 28, triggering a thermal runaway of other battery cell 28-2. Furthermore, the thermal runaway event 46 may spread from the first battery cell group 28 to the second battery cell group 30 and trigger thermal runaway of its battery cells 30-1, 30-2. Accordingly, such transfer of high-temperature gases and/or debris typically increases the likelihood of a chain reaction in the battery cell array(s) 26, affecting a significant part of the battery system 24.

As shown in FIGS. 3 and 4, the battery system 24 additionally includes a gas and debris collection bag 50 housed within the battery system enclosure 32. The collection bag 50 may be arranged above the battery cells 28-1, 28-2, 30-1, 30-2, between the battery cells and the enclosure cover 38. As shown, the collection bag 50 may extend across a row of battery cells in the respective first or second battery cell group 28, 30 or across each battery cell in both the first and the second battery cell group and substantially parallel to an inner surface of the enclosure cover 38. The collection bag 50 includes an exterior surface 50A and an interior surface 50B. The collection bag 50 is fixed to each of the first and second battery cells 28-1, 28-2 of the cell groups 28 and to the battery cells 30-1, 30-2 of the cell group 30.

The collection bag 50 is configured to capture high-temperature gases 52A and/or debris 52B vented by at least one of the first and second battery cells 28-1, 28-2 or 30-1, 30-2. The collection bag 50 is also configured to divert the captured high-temperature gases 52A and/or debris 52B away from the other of the first and second battery cells 28-1, 28-2, 30-1, 30-2 to thereby reduce (relative to an open space between the battery cells and the enclosure cover) and minimize transfer of the high-temperature gases 52A and/or debris 52B between the battery cells in the battery system enclosure 32. The collection bag 50 thus mitigates propagation of the thermal runaway event 46 in the battery system 24. The collection bag 50 is further configured to expel the captured high-temperature gases 52A and/or debris 52B to the external environment 34.

As shown in FIGS. 3 and 4, the collection bag 50 may include an exit port 54. The exit port has a one-way fluid exhaust valve 56 configured to control expelling of the high-temperature gases 52A from the collection bag 50 to the external environment 34. The exit port 54 may be fixed to either the enclosure tray 36 or to the enclosure cover 38, such as via a snap-together connection at the one-way valve 56. The collection bag 50 may also include an individual entry port 58 for each respective battery cell in the first and second cell groups 28, 30, such as for the battery cells 28-1, 28-2, 30-1, and 30-2. Each of the entry ports 58 has a respective interface 60 configured to lock onto a respective battery cell in the first and second cell groups 28, 30 at the respective cell vents 31. Specifically, the interface 60 may include a snap on or snap together mechanism permitting the collection bag 50 to be quickly connected to the respective battery cells. Individual interfaces 60 may be configured to simultaneously engage a plurality of battery cells in each of the cell groups 28 and 30, or, alternatively, each interface 60 may be configured to engage an individual battery cell, such as an individual interface for each of the cells 28-1, 28-2, 30-1, and 30-2.

As shown in FIG. 3-5, the collection bag 50 may additionally include a plurality of individual mica material portions 62 and 64. Each mica material portion 62 is arranged on the interior surface 50B surrounding one of the respective interfaces 60 to line, i.e., cover and reinforce, the respective entry port 58 and thermally protect the interface at the corresponding battery cell of the first and second cell groups 28, 30. Each mica material portion 64 is arranged on the interior surface 50B opposite and above the respective entry port 58 to line the collection bag 50 in the region where the hot gases 52A and/or debris 52B impinge on the interior surface. The mica portions 62 and 64 may be glued to the interior surface 50B of the collection bag 50. The collection bag 50 may be constructed from a flexible, temperature-resistant material. The material of the collection bag 50 may, for example, be black slag or vermiculite.

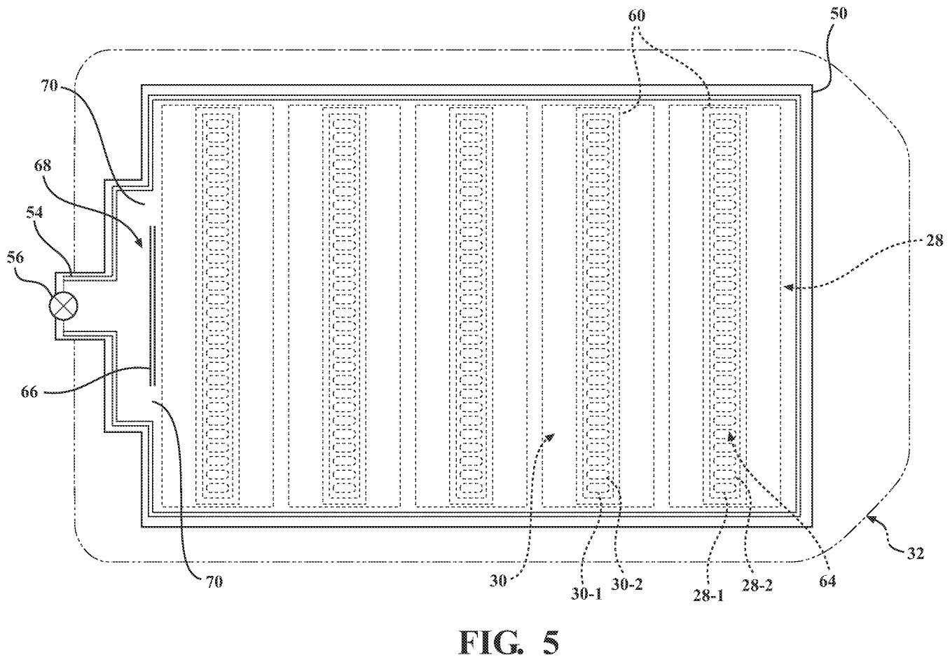

As shown in FIG. 5, the collection bag 50 may include stitching 66 bringing interior surface 50B of two opposing (e.g., upper and lower) sides together in certain regions 68 of the bag. The stitching 66 thus generates individual flow paths or channels 70 for the high-temperature gases 52A and/or debris 52B of each battery cell of the first and second cell groups 28, 30. The individual flow paths 70 generated via the stitching 66 may operate as bounded passages for the high-temperature gases 52A, each fluidly connected to the exit port 54. Each individual flow path 70 is configured to reduce the likelihood of high-temperature gases 52A being released uncontrollably into the interior of the battery system enclosure 32 during a thermal runaway of one or more of the constituent battery cells.

Each individual flow path 70 is specifically configured to divert the high-temperature gases 52A and/or debris 52B away from other battery cells in the corresponding group of battery cells 28 or 30, and also from another, adjacent group of battery cells. Such operation of the individual flow paths 70 is designed to reduce transfer of the high-temperature gases 52A and/or debris 52B between battery cells of the first group of battery cells 28 and between battery cells of the second group of battery cells 30. The individual flow paths 70 also reduce transfer of the gases 52A and/or debris 52B between the first and second groups of battery cells, e.g., from the first group of battery cells to the second group of battery cells, to mitigate or control propagation of the thermal runaway event 46 in the battery cell array 26.

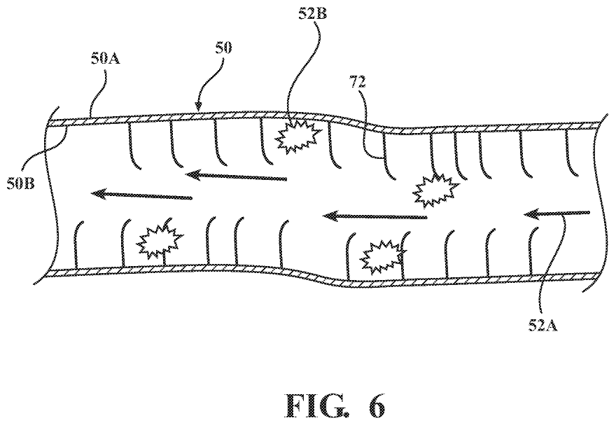

With continued reference to FIG. 6, the collection bag 50 may further include projections 72 arranged inside the individual flow paths 70. The projections 72 are configured to catch the high-temperature debris 52B after they are expelled from the battery cell undergoing a thermal runaway event 46. The projections 72 may therefore retain the high-temperature debris 52B inside the collection bag 50 and stop the debris from being ejected into the external environment 34 from the exit port 54. The collection bag 50 may include a bellows structure 74, such as between the opposing upper and lower sides. The bellows structure 74 is configured to add further flexibility to the collection bag 50 by expanding under pressure of the high-temperature gases 52A during the filling of the bag when battery cell(s) in the battery system 24 experience a thermal runaway event 46.

In summary, the collection bag 50 is shaped to fit within the battery system enclosure 32 to collect high-temperature gases 52A and/or debris 52B released during a thermal runaway event by a battery cell in a respective battery group and guide such gases out of the enclosure to the ambient while trapping the debris therein. Specifically, during operation of the battery system 24, the collection bag 50 expels high-temperature gases to the external environment from each individual battery cell and diverts the gases away from other battery cells in the battery cell array(s) 26. The collection bag 50 may also trap hot battery cell debris. The collection bag 50 thereby reduces transfer of the high-temperature gases and/or debris between individual battery cells and mitigates propagation of the thermal runaway event in the battery system 24. The collection bag 50 may also include a one-way valve fixed to the battery array enclosure 32 and fluidly connected to individual flow paths generated via stitching 66 for controlling the discharge of high-temperature gases to the ambient.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A battery system comprising:
a first battery cell and a neighboring second battery cell;
a battery system enclosure surrounded by an external environment and configured to house each of the first and second battery cells;
a collection bag housed within the battery system enclosure, fixed to each of the first and second battery cells, and configured to:
capture high-temperature gases and/or debris vented by at least one of the first and second battery cells;
divert the captured high-temperature gases and/or debris of each of the first and second battery cells away from the other of the first and second battery cells to thereby reduce transfer of the high-temperature gases and/or debris between the battery cells and mitigate propagation of a thermal runaway event in the battery system; and
expel the captured high-temperature gases and/or debris to the external environment.

2. The battery system of claim 1, wherein the collection bag includes an exit port having a one-way valve configured to control expelling of the high-temperature gases from the collection bag to the external environment.

3. The battery system of claim 2, wherein the battery system enclosure includes an enclosure tray and a mating enclosure cover, and wherein the one-way valve is fixed to one of the enclosure tray and the enclosure cover.

4. The battery system of claim 3, wherein the collection bag is arranged between the enclosure cover and the first and second battery cells.

5. The battery system of claim 1, wherein the collection bag includes individual first and second entry ports with respective first and second interfaces configured to lock onto the respective first and second battery cells.

6. The battery system of claim 5, wherein the collection bag includes first and second mica material portions arranged to line the respective first and second entry ports and thermally protect the respective first and second interfaces.

7. The battery system of claim 1, wherein the collection bag is constructed from a flexible, temperature-resistant material and includes stitching configured to generate individual flow paths for the high-temperature gases and/or debris of each of the first and second battery cells.

8. The battery system of claim 7, wherein the collection bag additionally includes projections arranged inside the individual flow paths configured to catch and retain the debris inside the collection bag.

9. The battery system of claim 7, wherein the flexible, temperature-resistant material includes one of black slag and vermiculite.

10. The battery system of claim 1, wherein the collection bag includes a bellows structure configured to expand under pressure of the high-temperature gases.

11. A motor vehicle comprising:
a power-source configured to generate power-source torque; and
a battery pack configured to supply electrical energy to the power-source, the battery pack including:
a first battery cell and a neighboring second battery cell;
a battery system enclosure surrounded by an external environment and configured to house each of the first and second battery cells;
a collection bag housed within the battery system enclosure, fixed to each of the first and second battery cells, and configured to:
capture high-temperature gases and/or debris vented by at least one of the first and second battery cells;
divert the captured high-temperature gases and/or debris of each of the first and second battery cells away from the other of the first and second battery cells to thereby reduce transfer of the high-temperature gases and/or debris between the battery cells and mitigate propagation of a thermal runaway event in the battery system; and
expel the captured high-temperature gases and/or debris to the external environment.

12. The motor vehicle of claim 11, wherein the collection bag includes an exit port having a one-way valve configured to control expelling of the high-temperature gases from the collection bag to the external environment.

13. The motor vehicle of claim 12, wherein the battery system enclosure includes an enclosure tray and a mating enclosure cover, and wherein the one-way valve is fixed to one of the enclosure tray and the enclosure cover.

14. The motor vehicle of claim 13, wherein the collection bag is arranged between the enclosure cover and the first and second battery cells.

15. The motor vehicle of claim 11, wherein the collection bag includes individual first and second entry ports with respective first and second interfaces configured to lock onto the respective first and second battery cells.

16. The motor vehicle of claim 15, wherein the collection bag includes first and second mica material portions arranged to line the respective first and second entry ports and thermally protect the respective first and second interfaces.

17. The motor vehicle of claim 11, wherein the collection bag is constructed from a flexible, temperature-resistant material and includes stitching configured to generate individual flow paths for the high-temperature gases and/or debris of each of the first and second battery cells.

18. The motor vehicle of claim 17, wherein the collection bag additionally includes projections arranged inside the individual flow paths configured to catch and retain the debris inside the collection bag.

19. The motor vehicle of claim 11, wherein the collection bag includes a bellows structure configured to expand under pressure of the high-temperature gases.

20. A motor vehicle comprising:
a power-source configured to generate power-source torque; and
a battery pack configured to supply electrical energy to the power-source, the battery pack including:
a first battery cell and a neighboring second battery cell;
a battery system enclosure having an enclosure tray and a mating enclosure cover, surrounded by an external environment, and configured to house each of the first and second battery cells;
a collection bag housed within the battery system enclosure, fixed to each of the first and second battery cells, and configured to:
capture high-temperature gases and/or debris vented by at least one of the first and second battery cells;
divert the captured high-temperature gases and/or debris of each of the first and second battery cells away from the other of the first and second battery cells to thereby reduce transfer of the high-temperature gases and/or debris between the battery cells and mitigate propagation of a thermal runaway event in the battery system; and
expel the captured high-temperature gases and/or debris to the external environment;
wherein the collection bag includes an exit port having a one-way valve configured to control expelling of the high-temperature gases from the collection bag to the external environment, and wherein the one-way valve is fixed to one of the enclosure tray and the enclosure cover.
